(19) United States
(12) Patent Application Publication
(10) Pub. No.: US 2004/0185422 A1
(43) Pub. Date: Sep. 23, 2004

(54) Data base, tooth model and restorative item constructed from digitized images of real teeth

(75) Inventors: Ulrich Orth, Lautertal (DE); Steffen Teckentrup, Heppenheim (DE); Volker Wedler, Hirschberg (DE); Ulf Willers, Darmstadt (DE)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: Sirona Dental Systems GmbH

(21) Appl. No.: 10/804,089

(22) Filed: Mar. 19, 2004

(30) Foreign Application Priority Data
Mar. 21, 2003 (DE) 103 12 848.4

(51) Int. Cl. A61C 11/00

(52) U.S. Cl. 433/213

(57) ABSTRACT

The invention relates to a data base for the storage of data, which comprises dental data relating to real teeth in the form of digitized images, which digitized images involve universally applicable dentition-specific and/or universally applicable tooth-specific features or structural properties, such as sex-specific and/or tooth family-specific and/or biography-specific and/or person-specific characteristics, with or without anomalous characteristics.

It also relates to a tooth model, whose outer and inner surfaces and/or internal structure are specified by means of data from a data base and are displayed on an output device, and, in particular, the data used for this purpose are taken from a data base and are suitably adapted.

The invention also relates to a method of conceiving a tooth model whose external shape and/or internal structure are designed and/or constructed by means of data which represent sex-specific and/or race-specific and/or biography-specific and/or person-specific characteristics, with or without anomalous characteristics, wherein the user and/or the client, with the aid of an electronic data processing system, accesses data base(s), combines these data on display means to form an image of a tooth model, and, with the aid of said image of a tooth model, produces the tooth model, whose shape can be processed with the aid of the input and output devices of the electronic data processing system.

The invention relates to a data base, a tooth model and a restorative item, which have been constructed with the aid of digitized images of real teeth.

### BACKGROUND OF THE INVENTION

The prior art comprises collections of individual (real) teeth from one or more dentitions, or models of teeth for a denture produced more or less individually by the dental laboratory technician. A drawback of these collections is that they are not present in data sets capable of being stored in EDP systems

Furthermore, tooth models exist as individual models for each position in the jaw. These are intended in the widest sense for visual instruction purposes and to help answer questions on dentistry in a plastic and practical manner. Such models are obtainable from relevant business sources.

Furthermore, diverse manufacturers have produced EDP programs which form images of individual teeth or tooth-specific characteristics, such as occlusal surfaces or edges of teeth or the like, and display them on a computer monitor.

In addition, libraries of teeth and respective data have been known for many years, these objects being both in the form of physical models and in digitized form. A disadvantage here is that only standardized (plaster) teeth are present. Standardized teeth of other materials are also used for inclusion in prostheses.

Furthermore, there are tooth libraries resulting as the by-product of a processing operation and produced for making a specific product as demanded by a particular situation. Furthermore, tooth libraries are known which comprise a very restricted number of representative tooth or jaw models in coded form, which are primarily intended for use as illustrative material for, say, instruction purposes. The drawback of such tooth libraries is that they contain no tooth or dentition data of a large number of real persons. In general, these libraries are characterized in that the properties of the objects are not systematically categorized and/or cataloged.

Furthermore, software by Nobel Biocare “Procera™ System” is known for the construction of crown copings based on externally supplied data and not on data coming from the system s own data base. A disadvantage of this software is that no display of the occlusal surface is possible using said software.

Furthermore, diverse programs for orthodontology are available, as described in WO 02/102270 for example, which are primarily used for diagnostic purposes and for determining the ratio of the upper jaw to the lower jaw. The object of such programs is generally to show tooth movements in the jaw and effect planning thereof. Experience has shown that these programs are not suitable for effecting plastic alteration of the displayed appearance of the tooth representations themselves.

Furthermore, computer programs are known in which teeth are represented by teeth-typical lines such as biting edges or chewing lines or the like, which lines can be stored if desired. The object of these and other lines necessary for this purpose is to represent a tooth to such a wide extent that a surface of the tooth is reconstructed with reference to these lines with the aid of mathematical processes, for example by interpolation. A drawback of these computer programs is that a tooth reconstructed in such a manner can provide, with the aid of mathematical methods, a virtual representation of a tooth as it is in reality, theoretically only when use is made of a data base of infinite size in conjunction with boundless computer capacity.

Software is also known which is based on the application FR 2 735 679 or WO 02/076326 and is marketed under the trade name Cynovad Pro 50™. It relates to a method of producing dental restorations and only includes the possibility of storing individual constructional results without storing them in a data base, however. Moreover, the representation produced by the software on the basis of lines cannot represent surfaces as they are in reality.

For the purposes of this application the terms “tooth library” or “tooth data bank” will be used to designate a data base/library which contains a number of digitized tooth shapes of real teeth including information on the owner of each tooth and/or structural elements of the tooth.

It is an object of the present invention to overcome the drawbacks of the prior art by providing a tooth model which lacks the above drawbacks because it has improved relationship with reality.

### SUMMARY OF THE INVENTION

This object is achieved according to the invention by the features of the independent claims, advantageous developments thereof being characterized in the respective subclaims.

According to the invention, a data base for the storage of data, which comprises dental data concerning universally applicable dentition-specific and/or universally applicable tooth-specific features, is characterized in that the dental data represent real teeth in the form of images in digitized form and this digitized form also involves universally applicable dentition-specific or tooth-specific features or structural properties, such as sex-specific and/or tooth family-specific and/or to biography-specific and/or person-specific characteristics, with or without anomalous characteristics. These digitized images of real teeth can be obtained in a variety of ways. A conceivable method is, for example, to use a three-dimensional scanning process in the mouth of the person providing the desired information, or alternatively to make an impression of a tooth, which is then cast to provide a model for scanning.

One advantage of dental data relating to real teeth in digitized form is that they can be stored as teeth of an individual in digitized form, in order that they can be used at a later date, eg, as illustrative material in cases where the relevant real tooth has been lost. In this way, a corresponding representative having all of the precise morphological features characterizing it can be shown. In this way alternative operation using construction lines, as has hitherto been necessary, becomes facultative.

Another advantage of dental data relating to real teeth is that in cases where no data have previously been stored for an individual it is possible to provide a very precise replacement having all details existing in reality as a virtual replacement. Unlike a mathematically interpolated representative, a representative can be filtered out which, for example, has approximately the right dimensions and also the same number of cusps as desired by the client.

By “structural properties” we mean here those properties which are, for example, constitutively present in each dentition and in each tooth, such as sex-specific and/or tooth family-specific and/or biography-specific and/or person-specific characteristics with or without various anomalous characteristics. These represent the first and coarsest means of labeling or sorting the data by way of structural features inevitably inherent in each dentition and/or tooth. Furthermore, sorting may be carried out according to the equator line, the marginal crest, or the fissure, and the preparation edge, if present.

Sorting according to sex-specific characteristics in the data base takes into account the fact that teeth of persons of the same sex have the same structural features, ie teeth of men differ in shape from identically positioned teeth of women; and sorting of a data base according to tooth family-specific criteria takes into account, inter alia, the fact that identically positioned teeth within the same tooth family exhibit the same structural features, depending on whether the owner of the dentition is a member of, say, an Asian, African, or European race. A more extensive and finer classification of the tooth family features could be made, for example, according to the number of cusps, the equator line, the marginal crest, or the fissure or according to whether a mandibular tooth has a U or V shape or a maxillary tooth an oval, triangular, or square shape, and according to any preparation edge that may be present, etc. Furthermore, sorting of the data in the data base according to biography will take into account the fact that the dentition of one and the same person will retain certain structural features during his or her entire life. For example, data recorded in early years can again be used at a later stage of life, or a tooth may be represented which, like the rest of the dentition, exhibits dentition-specific abrasion due to a preference for a certain type of food. And a data base sort according to person-specific characteristics will take into account the fact that in the dentition of one and the same person certain structural features will always be present, such as the fact that contralateral teeth exhibit a very high degree of similarity.

In this way it is possible, for example, in cases where no data were recorded in early years, to use a mirror image of the opposite tooth on the other side, for example, as a source of data if another tooth should have been lost and no image thereof had been created in early years. Moreover, a manual sort according to anomalies will take into account the fact that certain anomalies relating, eg, to the shape of the tooth, or to the fact that tooth No. 2 is missing, are known by experience to be present at a number of sites in the dentition or continuously throughout the dentition. By this means the user of the data base will have an optimal starting point for purposes of illustration and education, from which other plans can be efficiently made.

Another advantage of such a data base is that the shape of a tooth model formed on the basis of such an optimized starting position can be individually modified as the situation demands and such modifications can be immediately illustrated three-dimensionally. In this way the client experiences immediate visual instruction, since he immediately sees the results when his individual ideas are put into practice. This is, in particular, of advantage in cultural areas in which esthetic appearance is of great importance. In India, for example, a continuous cutting edge of each of the four incisal teeth is an accepted sign of beauty. In USA very much attention is paid to the esthetic appearance of the anterior teeth as regards color and shape, including that of the diastema, for example. Also conceivable is the representation of an artistic design on the individual real tooth involving, for example, coloring, engraving, or decorating elements, such as are becoming increasingly conspicuous in juvenile culture, for example in the form of a small diamond or other object used for piercing.

Thus the client has direct access to data showing a good relationship with reality and obtains a reference model which is possibly optimized according to his own ideas and with the aid of which he can then select a suitable artist, who will be in a position to impart the previously chosen artistic measures to the real tooth, or a doctor, who will be able to carry out a diagnosis, based on which a treatment schedule can be set up to achieve the treatment target previously defined by the client and capable of being represented in three dimensions with the aid of a tooth model. A great advantage in this context is that the client can acquire, prior to any diagnosis or treatment, an expert opinion which is not affected by the interests of a doctor, and he is in possession thereof in the shape of a tooth model serving as a three-dimensional reference object. This reference model can then, before commencement of a diagnosis or treatment, facilitate the decision as to whether or not treatment should be commenced, and it can be used during treatment once started as a benchmark for monitoring the success of the treatment. The client is thus initially independent of the opinion of a doctor and can himself have an active influence on diagnosis and/or treatment then commencing and can monitor the course thereof.

By an “ideal tooth” is meant, accordingly, a tooth which is constructed and/or designed in accordance with specific information concerning the client and those data of the data base which are typically ideal within given limitations (objectively ideal) or which have been selected according to the individual concepts of the client (subjectively ideal), or which are objectively ideal and have been additionally modified by the client according to subjective criteria.

Advantageously, these data can be additionally assigned to two further groups of data, ie data concerning the dentition and data concerning the tooth, in order that the data base can be composed of dentition structures and/or tooth structures.

Another advantageous dentition classification can refer to the number of teeth, their position relatively to each other, the character of the shape of the occlusal surface produced thereby, the shape of the Wilson curve or the shape of the curve of Spee, dental arch shapes, first premolar measuring point from 4 to 4, second premolar measuring point from 6 to 6 (6-year-old molar), crown size of the incisal teeth, and typical anomalies of the teeth in the dentition or in the jaw. Dentition-specific structures are therefore particularly meaningful when it is desired to show how the teeth cooperate with each other and to represent their function in combination.

Based on the existing dentition-specific structure of the data base, it is thus possible to find a particular dentition-specific structure from any number of individual dentition-specific structures of individual dentitions by selecting from the data base that number of data and that type of data which appears to the user to be most suitable. This first filtering step reduces the total number of available data to a smaller amount, as is relevant for further practical work; that is to say, a representative selection of data is made.

From this number of theoretically useful data the user will then select, either immediately or in second implementation step, at least one data set present in the data base and suitable for his present situation. This double filtration process advantageously guarantees that the most suitable data set can be filtered out from the data base to comply with present requirements.

Similar advantages result when this filtration process is applied to the tooth-specific data, as represented advantageously by the position of the individual tooth in the dentition, the shape of the individual tooth, eg, whether U-shaped or V-shaped or of an oval, triangular, or rectangular shape, the degree of matching of the tooth shape to the skull shape, the characteristics of the individual tooth, eg, its equator line, marginal crest, shape of the fissure (H-shaped or oblong), the number of cusps, Tuberculum carabelli, any preparation edge, the tooth shade and comparable features, and any typical anomalies.

If dentition-specific and tooth-specific features are combined, there is an increase in the probability of finding that dentition and tooth situation in the data base which comes closest to the starting requirements.

Another advantage arises when a tooth model is created from data of a data base which not only includes the data of teeth but also dental design features based on the tooth or teeth individually or as a representative group of teeth (eg, tooth number 6 in female Asians). Thus, for example, an ideal cutting edge of an anterior tooth of a female Asian woman can be stored on the basis of a large number of such teeth and can thus be represented as such.

It is particularly advantageous when the user of the data base (tooth-specific and/or design-specific) has the data available on his own data processing facilities so as to minimize reaction times and, consequently, the processing times. Furthermore, there is an added advantage for the user of the data base when he is able to access, eg, for the information of a client from a different part of the world, a different data base which has the typical data sets for that part of the world but is not presently available at home. In this way, the user can comply with typical requests of unusual clients, and to unusual requests coming from clients who would otherwise be regarded as being typical. Such connections to data bases and between data bases are simple to set up using the diverse telecommunication facilities available.

Creating an ideal tooth of appropriate type is particularly facilitated when the data base is equipped with at least one input unit, such as a keyboard, mouse, joystick, pointer etc. and/or with at least one output unit, such as a printer or monitor. By this means it is possible for the data base user or for the client to communicate directly with the data base by, for example, directly accessing the data base and fetching data therefrom, which are then shown on the display unit. By this means the user or client can, if desired irrespective of filtering, have direct active access to the data base and can thus actively search for data. The user can also have direct access to the data base using said input and output units.

Another advantage results when the interaction between the user and/or client with the input units and/or display units and data bases is supported by at least one computer program. Such a program can, for example, facilitate the selection of relevant data by means of filtering; furthermore, it can, for example, make the representation look more plastic and more natural by the use of colors or three-dimensional images; it can furthermore make it possible to assign selected data to a client; in addition, sections can be inserted at various places, for example; and it is also possible to block access or allow only stepwise access for diverse groups of users; besides, the depth of interaction obtainable with the program, for example, permission as to who may enter/fetch what data, can be adjusted as the situation demands; and not least there is the possibility of combining diverse data sets and showing a group of data sets obtained by the combination of at least two data sets to form a single new data set.

A commonly used operational aid constitutes down-loading data from the pool of data with the aid of fixed routines of an EDP program, for example, to comply with a request to filter out a representative tooth of a 35-year-old Asian of the male sex from a certain country. Furthermore, it might be necessary to meet a request to design an ideal tooth which, irrespective of the assignment of the aforementioned groups, requires certain geometrical data that are regarded as being important to the user and/or client.

Another advantage is attained when the possibility of exchanging data between the operating or display terminals is only allowed under a payment system. This forms a basis of reward for data base companies for their efforts in maintaining a wide range of data and keeping them up-to-date and for making them available to third parties. Such payment systems could exist between two users, or payment could be made via a central payment service.

Using a computer program it is possible to combine selected data sets of real teeth to form a single new data set for a virtual, non-real tooth. In this way the existing data sets can be linked to each other for the purpose of making new data sets, in which case the user can set the linkage rules.

Another advantage of a computer program would be, for example, the possibility of taking a displayed tooth possibly preselected according to certain criteria and processing it by means of computer programs by slightly or completely modifying, say, the form of the bite edges on the monitor in accordance with the concepts of the client, or by making the entire shape slightly more rounded or more pointed, or, for example, by making a depression somewhat shallower. Programs having such representation means are capable of individually fulfilling, on the basis of specific data, the user's wishes and to develop and improve the ideal tooth, the results being directly displayed on the monitor for control by the user and/or client.

Another great advantage results when the representation of the ideally developed and designed tooth, for example, can be displayed three-dimensionally by means of computer programs and moved about all axes in space. Such a three-dimensional representation has a particularly plastic effect when it is displayed on a 3D monitor and is, in particular, for aesthetic consultation highly advantageous.

Another advantage results when a data set is suitable for representing a complete tooth model and not only a part of a possible tooth, or an individual tooth. Such a tooth mo-model may represent a group of teeth, such as a bridge, or an entire row of teeth. Instead of showing a group of teeth, it is alternatively possible to display only the occlusal surface, for example, in order to illustrate by this means, say, the cooperation of individual teeth in the entire chewing system.

Advantages of a tooth model, whose outer and inner surfaces and/or whose internal structure is determined by means of data taken from a data base and/or several data bases and displayed on an output device, are that the construction or design thereof can take into account sex-specific and/or tooth family-specific and/or biography-specific features and/or person-specific characteristics, with or without anomalies, individually, or in combination with each other. In this way, it is possible to select the relevant data sets from the large number of tooth models based on data sets in an efficient manner, eg, by viewing the monitor.

Another advantage results when the tooth model is constructed and/or designed such that it not only serves for visual instruction purposes but also for informing and/or influencing professionals due to the fact, for example, that the internal structure of the tooth model corresponds to the internal structure of an ideal tooth.

Furthermore, another advantage is gained when not only individual teeth or groups of teeth or occlusal surfaces are represented but also the cooperation occurring when opposite teeth or occlusal surfaces impinge on each other, in order to show, by this means, their interaction in a plastic, three-dimensional manner.

Another advantage results when the tooth model represented, eg, with the aid of a computer program in the form of an individual tooth and/or group of teeth and/or surface of a tooth, and/or the cooperation of opposite chewing crests can be realized not only on the monitor or printer or the like but also just in time as a 3-dimensional model.

Another advantage results when a user takes a tooth model synthesized on the basis of data from the data base, for example, and then processes it by means of computer programs, such as CAD programs, according to his own concepts, thereby individualizing it. This can be carried out interactively, eg, with the aid of a dialog program or expert system.

Particularly advantageous is a method of conceiving a tooth model whose external shape and/or internal structure is designed and/or constructed by means of data which relate to sex-specific and/or race-specific and/or biography-specific and/or person-specific characteristics, with or without anomalous characteristics, when the user and/or the client accesses said data base containing the relevant tooth-specific data with the aid of an electronic data processing system via its input device such as a keyboard and/or mouse and its display device such as a monitor and/or printer and combines these data on the display means to form an image of a tooth model and produces the combined and displayed tooth model, whose shape can be individually processed as dictated by the user and/or client with the aid of the input and output devices and supporting computer programs.

This method is particularly advantageous when it is possible to produce a 3-dimensional representation of the tooth model.

Another advantage is achieved when the displayed tooth model can, for example, be just in time produced as a 3-dimensional model.

Another advantage results when a model produced in such manner is not only suitable for education and training purposes relating to artistic design or medical diagnosis but also for a particular situation of a client.

Advantageously, the 3-dimensional model is a dental fitted shell which relates to a particular situation, existing or planned, of a client, eg, a restorative item.

### BRIEF DESCRIPTION OF THE DRAWINGS

Embodiments of the invention are illustrated in the figures, in which:

FIG. 1 is a block diagram illustrating the depth to which the data base can be accessed;

FIG. 2 is block diagram demonstrating the routine for accessing the data base;

FIG. 3 is a flow chart concerning imaging of an individual tooth;

FIG. 4 is a flow chart concerning imaging of the preparation;

FIG. 5 shows several teeth of a tooth family in an occlusal surface;

FIG. 6 shows possible construction lines, which can be stored together with the data of a tooth;

FIG. 7 demonstrates the cooperation between the data base and the user and/or client;

FIG. 8a shows the state of a tooth before a structural alteration;

FIG. 8b shows the state of a tooth after a structural alteration;

FIG. 9a is a 3-dimensional representation of a tooth;

FIG. 9b is a rotated 3-dimensional representation of the tooth of 9a;

FIG. 10 shows a tooth model following just in time production based on ideally designed individual teeth.

### EXAMPLE

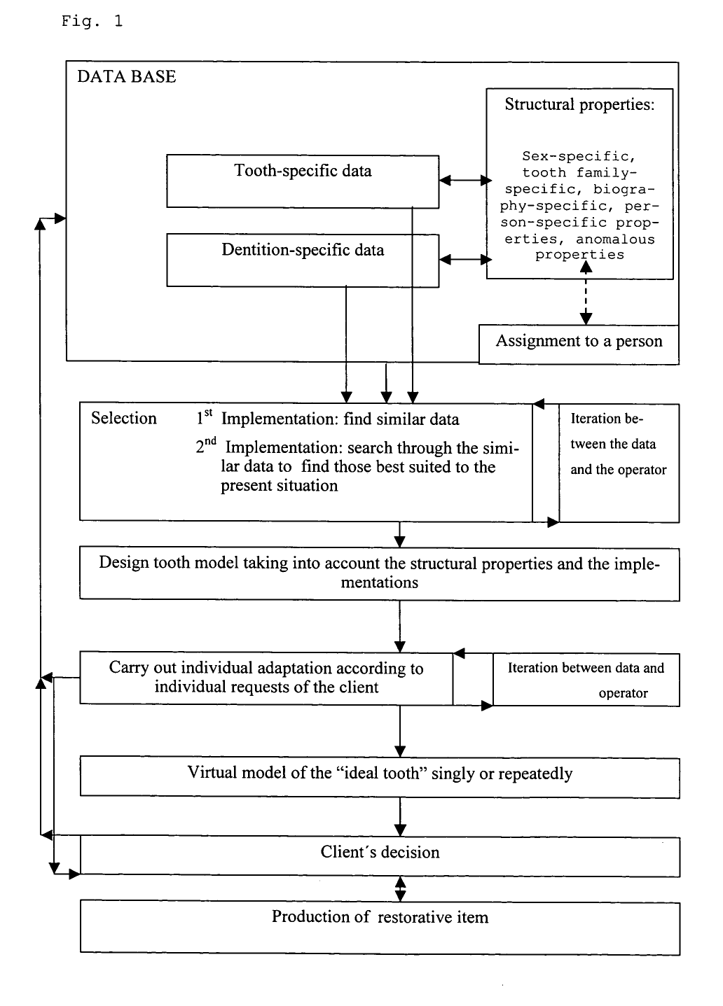

Specifically, FIG. 1 shows a possible overall access sequence when accessing a tooth data bank. The data base itself contains, in particular, digitized images, such as binary coded images, of real teeth together with tooth-specific and/or dentition-specific data of the kind inevitably and inseparably associated, as structural features, with each individual tooth and/or dentition. These include, in particular, sex-specific and/or tooth family-specific and/or biography-specific and/or person-specific characteristics with or without anomalies. The assignment of the data to persons is optional. These data serve not only to provide EDP-typical characteristics such as memory location or the like but also to characterize and thus ultimately to identify each individual tooth. In a first implementation step, the user or, if versed in the operation of the data base, the client, will approach the data base with his particular requests and make a selection of data based on these requests. One possible request might be, for example, for typical tooth models, also designated as “representatives”, for a 45-year-old male Asian coming from Tokio, who has hitherto mainly lived on fish products and shows no anomalies. The search criteria can be further refined by means of software-supported, freely and finely adjustable filters (not shown) until a representative number of data sets has been obtained.

Suitable filters relate, for example, to the following criteria: sex-specific and/or tooth family-specific and/or biography-specific and/or person-specific characteristics with or without the number of cusps, with or without equator line indices, with or without specific fissure shapes (H-shaped or oblong), with or without a marginal crest or with a U-shaped or V-shaped mandibular tooth or an oval, triangular, or square-shaped maxillary tooth, with or without any preparation edge possibly present, or any abrasion due to dietary habits (eg, caused by eating fish, cereals, or meat), and with or without various anomalous characteristics or the like.

This first implementation step may be omitted or, on the basis of the number of representatives found in this first implementation step, a (second) implementation step can then by carried out, taking into account individual requests, in an iterative process between the user and the data base in order to select a single item. Alternatively, a group of dental data relating to real teeth may conceivably be linked by means of software so as to synthesize a new virtual set of dental data which is based on existing dental data and is an average of data concerning real teeth but is not in itself assignable to any real tooth.

Following the selection of an apparently suitable data set, the data thus found on the basis thereof are used to make a design of an objectively ideal tooth, which is represented on an EDP output medium as a tooth model for information purposes.

On the basis of this information, the user/operator can then either create the model illustrated or, by means of software programs such as CAD tools, himself optimize individual aspects of the tooth model in an iterative process with the data base so as to develop the objectively ideal tooth to form a subjectively ideal tooth. For this purpose it is necessary that the dental construction lines of the CAD system can be proposed with reference to the 3D data set present and then manually adjusted to take into consideration certain dental problems. This also applies to dental features, such as the positions of cusp summits. The result can in turn be collated with the data of the data base in order to filter out a more suitable data set from the data base, which data set could then be regarded as a new objectively ideal tooth, or could be left in order to provide the data base with said self-produced data set for use by other users.

In this context it is conceivable to put the objectively or subjectively ideal tooth virtually into a dentition environment and to see and test its interaction with, and its fit in, the resulting environment.

At this stage, the user has all the information necessary to make a decision as to whether he wants to initiate a concrete diagnosis. In addition, he can call on a doctor particularly well qualified to deal with the present problem and present him with the information hitherto gained, so that said doctor can check the work procedure and the results thereof.

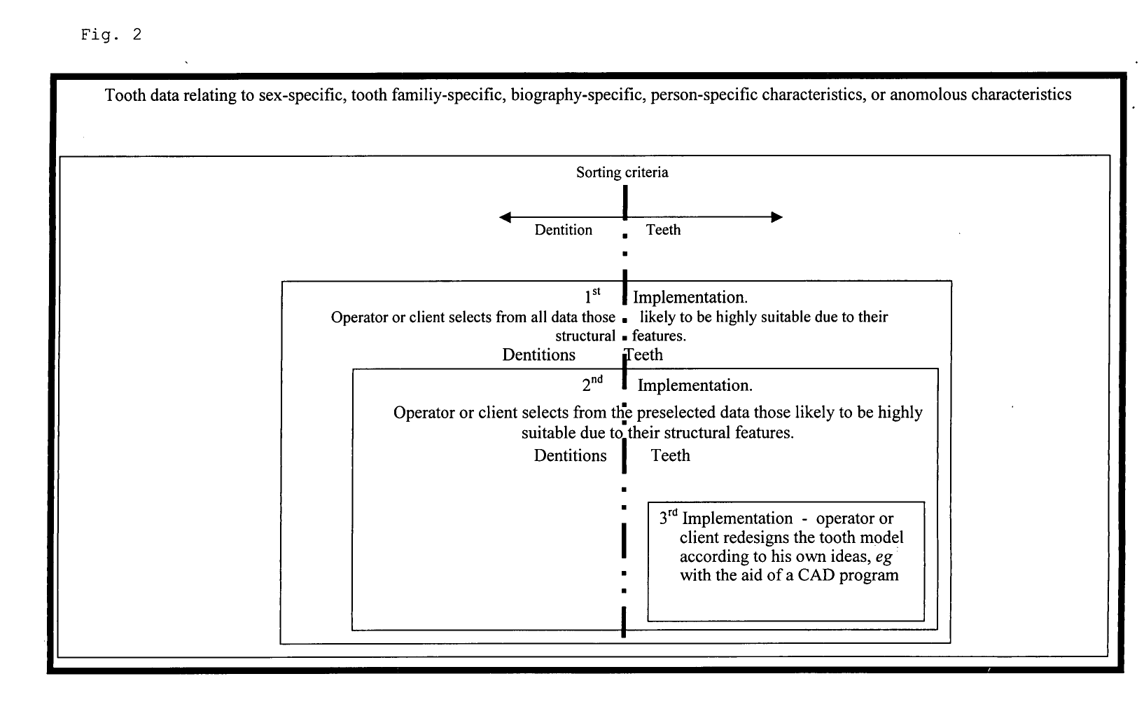

FIG. 2 demonstrates the progressive improvement in design up to the attainment of the desired tooth model with the aid of implementation stages. Starting from the data base containing dental data relating to sex-specific, tooth family-specific, biography-specific, person-specific, and anomalous characteristics, said data are first of all sorted into dentition data and dental data. In a first implementation stage, the operator or client selects from all data data those which, on account of their structural features, are likely to be highly suitable. In a second implementation stage, the operator or client selects from the preselected data the most suitable data set for the actual situation. In a third implementation stage, the operator or client re-designs the tooth model according to his own concepts, eg, with the aid of CAD means. Irrespective of the scheme shown here, the user can, of course, directly access the data base and fetch individual data sets, this not being indicated in FIG. 2.

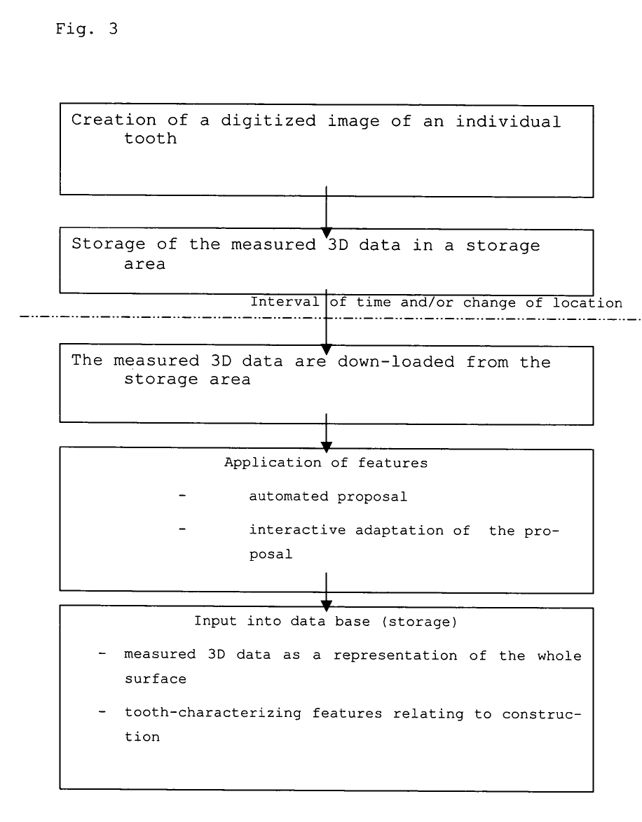

FIG. 3 shows the sequence of events taking place as from the inclusion of a binary image of an individual real tooth in the data base and the possible use of these data. After the measured 3D data have been stored in a storage area, an indefinite period of time may pass, during which the data are not required. The person concerned can request these data any time later and from any other location and possibly remotely down-load them as measured 3D data from the storage area and supply them with additional information, eg, by using an automated proposal or interactively adapting said proposal. The data stored in the tooth data bank are measured 3D data to represent the overall surface of the tooth and/or tooth-characterizing features relating to the structure of the tooth.

FIG. 4 shows the sequence of events taking place from downloading a binary image of an individual real tooth from the data base. In such a case suitable data are those which were acquired from the same tooth immediately after its eruption, or which were acquired during a condition prior to a preparation or which represent a mirrored contralateral tooth or some other “matching” tooth. These data can then be used in an impending restoration. If necessary, adaptation of construction-relevant features for characterization of the tooth may be carried out automatically or manually.

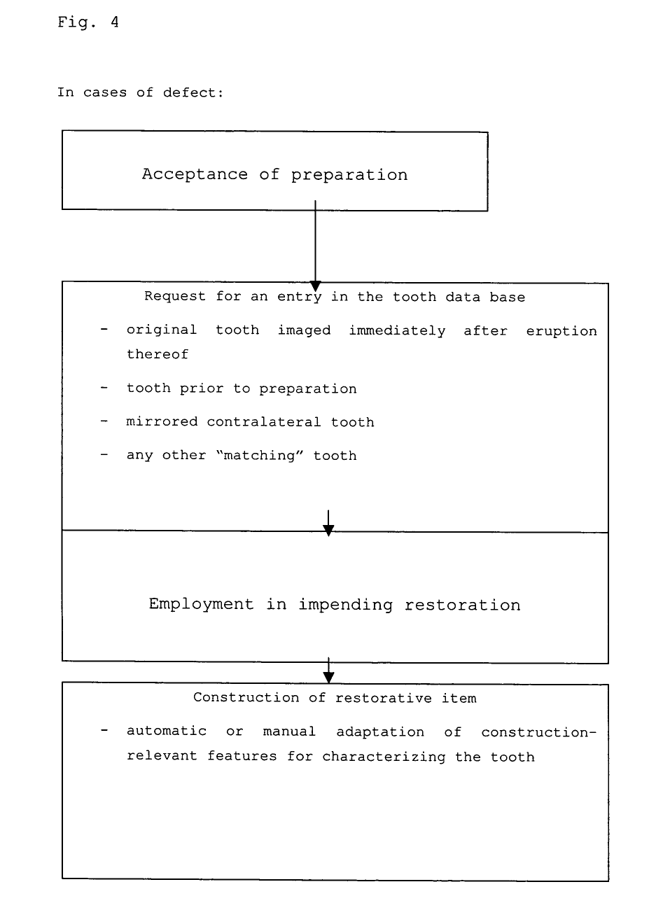

FIG. 5 shows several teeth of a tooth family in an occlusal surface and their mutually close fit. Tooth models fitted in this way into an environment can, particularly when they have been subsequently changed, be displayed and checked with respect to their effect and closeness of fit in the environment.

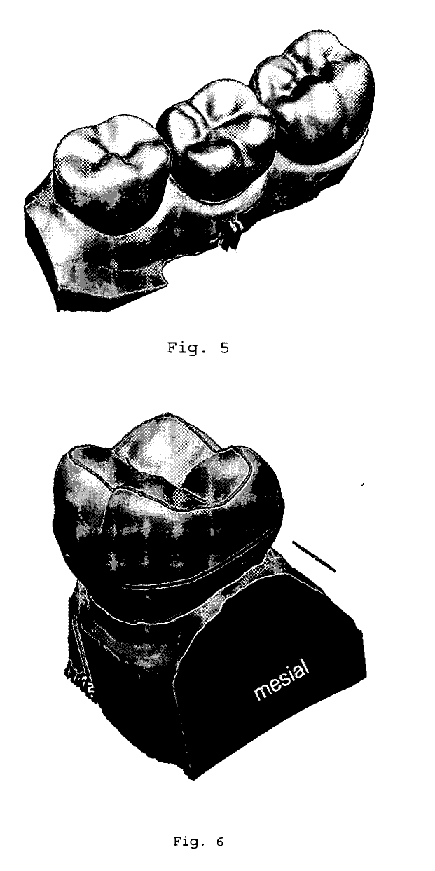

FIG. 6 shows a tooth in a mesial/top view with the occlusal surface as the selected area. In this surface there are shown possible construction lines, which can be stored together with the data concerning the tooth. With the aid of these construction lines it is possible to specify a tooth or, if it is an objectively ideal tooth, to modify it subjectively. Suitable for this purpose are, in particular, the characteristic construction lines, the equator line, the marginal crest, and possibly the preparation border.

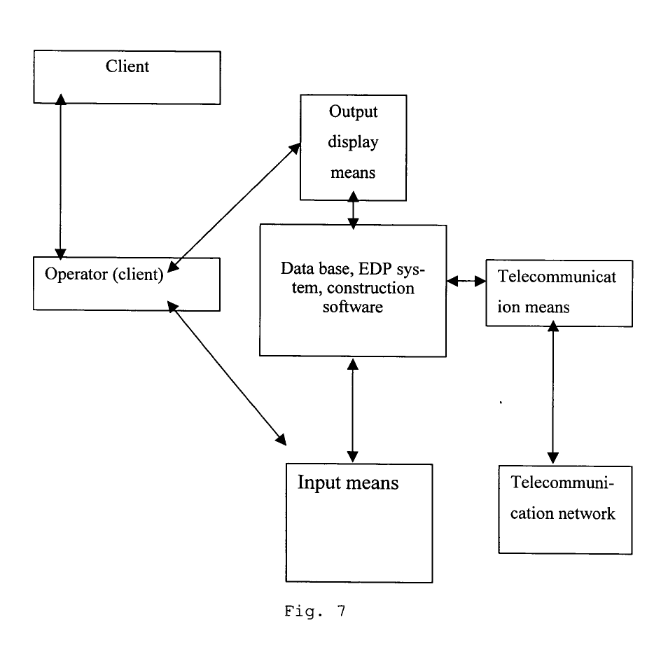

FIG. 7 shows the basis of interaction with the data base. The system comprises not only the data base and relevant input and output means but also construction software for designing individual tooth models. The operator associated with the client uses the output means, display means, and input means to interact with the data base or the EDP system or the software comprising the same. The data base can be connected to the telecommunication network, via telecommunication means, from which it can fetch data or to which it can send data.

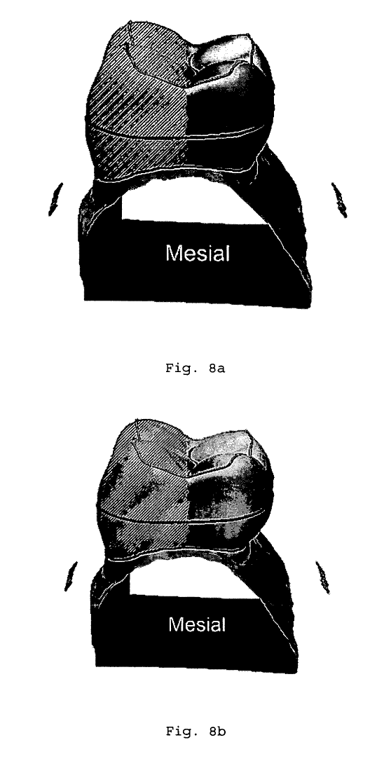

FIG. 8a shows the state of a tooth prior to a structural alteration of its right-hand external surface, whilst FIG. 8b shows the same tooth after a structural alteration has been made to its right-hand external surface to the effect that said surface has a more pronounced bulge.

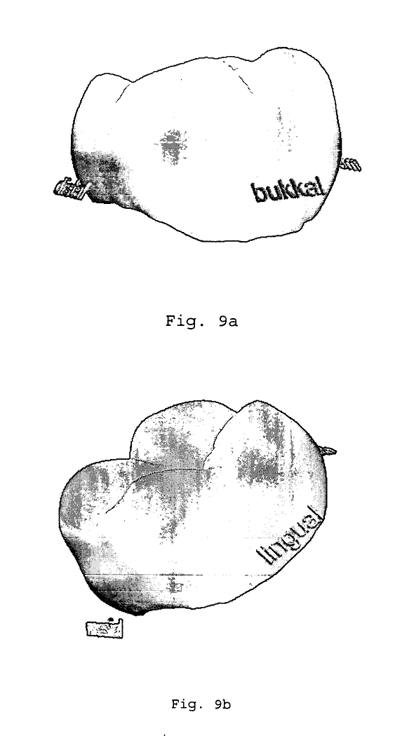

FIGS. 9a and 9b are 3-dimensional representations of the same tooth model in different rotated positions. In this way the tooth model can be viewed from all directions.

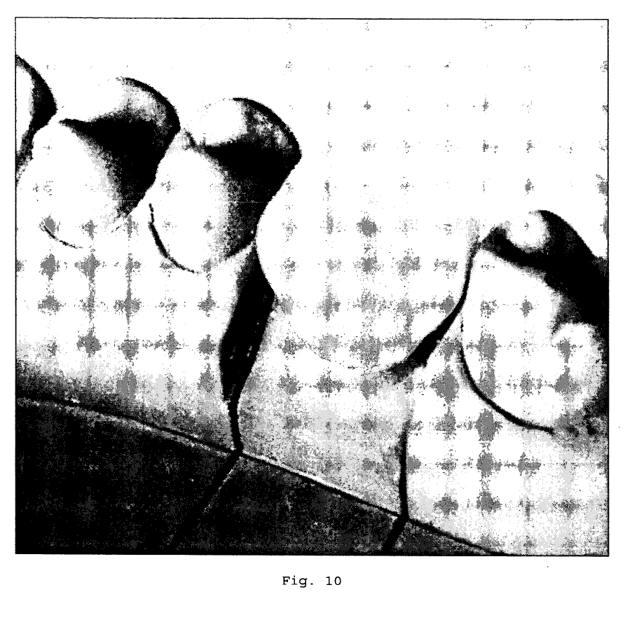

FIG. 10 shows a real tooth model following just in time production thereof, which model was developed on the basis of an ideal tooth model and then adapted to its environment.

1. A data base for the storage of data, which comprises dental data concerning universally applicable dentition-specific and/or universally applicable tooth-specific features, characterized in that the dental data illustrate real teeth as images in digitized form and this digitized form also involves universally applicable dentition-specific or tooth-specific features or structural properties, such as sex-specific and/or tooth family-specific and/or biography-specific and/or person-specific characteristics, with or without anomalous characteristics.

2. A data base as defined in claim 1, characterized in that the dental data are associated with an actual person.

3. A data base as defined in claim 1 and claim 2, characterized in that the dentition-specific structure comprises data representing the number, position, character, and anomalies of teeth of various types as well as their cooperation with each other.

4. A data base as defined in any one of claims 1 to 3, characterized in that a materialized dentition-specific structure has been ascertained from any number of individual dentition-specific structures of individual dentitions.

5. A data base as defined in any one of claims 1 to 4, characterized in that an individualized materialized dentition-specific structure has been ascertained from any number of individual dentition-specific structures of individual dentitions.

6. A data base as defined in any one of claims 1 to 5, characterized in that the tooth-specific structure consists of data which represent the position, shape, character, and anomalies of an individual tooth at any position in the dentition.

7. A data base as defined in any one of claims 1 to 6, characterized in that a materialized tooth-specific structure has been ascertained from any number of individual tooth-specific structures of individual teeth situated at the same position in the dentition.

8. A data base as defined in any one of claims 1 to 7, characterized in that an individualized materialized tooth-specific structure has been ascertained from any number of individual tooth-specific structures of individual teeth situated at the same position in the dentition.

9. A data base as defined in any one of claims 1 to 8, characterized in that in the data base(s) there are additionally stored data relating to dental design features based on the dentition-specific and/or tooth-specific structure.

10. A data base as defined in any one of claims 1 to 9, characterized in that the data base(s) are located directly on the premises, or when the data base(s) are not located on the premises, they can be situated at any place in the world and accessed by telecommunication means.

11. A data base as defined in any one of claims 1 to 10, characterized in that the data base is equipped with one or more input units and/or one or more output units.

12. A data base as defined in any one of claims 1 to 11, characterized in that the input units comprise a keyboard and the output units comprise display means and/or a monitor.

13. A data base as defined in any one of claims 1 to 12, characterized in that the client and/or user accesses the data base(s) with the aid of the input and display unit(s) and fetches data from them as shown on the display unit(s).

14. A data base as defined in any one of claims 1 to 13, characterized in that the interaction between the input unit(s), display unit(s), and data base(s) is supported by at least one computer program.

15. A data base as defined in any one of claims 1 to 14, characterized in that the exchange of data between the operating or display terminals is only possible with the aid of a payment system.

16. A data base as defined in any one of claims 1 to 15, characterized in that the computer program synthesizes a single new data set from selected data sets.

17. A data base as defined in any one of claims 1 to 16, characterized in that the data of the data base serve to construct a tooth model.

18. A tooth model, whose outer and inner surfaces and/or internal structure are specified by means of data and are displayed on an output device, characterized in that the data used for this purpose are taken from a data base and that the data are suitably adapted.

19. A tooth model as defined in claim 18, characterized in that the data comprise sex-specific and/or tooth family-specific and/or biography-specific and/or person-specific characteristics with or without anomalous peculiarities.

20. A tooth model as defined in any one of the previous claims, characterized in that the data exist as digital data and that the tooth model can be displayed as a 3-D representation.

21. A tooth model as defined in any one of the aforementioned claims, characterized in that the tooth model comprises a group of teeth.

22. A tooth model as defined in any one of the aforementioned claims, characterized in that it com-prises an occlusal surface comprising one or more teeth.

23. A tooth model as defined in any one of the aforementioned claims, characterized in that the data of the teeth opposite each other during chewing are taken into account.

24. A tooth model as defined in any one of the above claims, characterized in that the tooth model has been constructed with the aid of a tooth data bank and can be individualized by means of software support.

25. A tooth model as defined in any one of the above claims, characterized in that the tooth model has been constructed with the aid of the tooth data bank and can be interactively individualized according to the concepts of a person.

26. A method of conceiving a tooth model whose external shape and/or internal structure is designed and/or constructed by means of data which represent sex-specific and/or race-specific and/or biography-specific and/or person-specific characteristics, with or without anomalous characteristics, characterized in that the user and/or the client, with the aid of an electronic data processing system,
accesses said data base,
combines these data on display means to form an image of a tooth model,
and, with the aid of said image of a tooth model, produces the tooth model, whose shape can be processed with the aid of the input and output devices of the electronic data processing system.

27. A method as defined in claim 26, characterized in that the image of the tooth is displayed in three dimensions and can be processed.

28. A method as defined in claim 27 and claim 28, characterized in that the displayed image is just in time reproduced as a three-dimensional model.

29. A data base as defined in any one of the above claims, characterized in that the body displayed on the display unit(s) is a tooth model of a dental close-fit replacement item corresponding to an actual treatment situation, planned or existent.

30. A restorative item as defined in any one of the previous claims, characterized in that it has been designed using a tooth model and/or a tooth data bank and is produced therefrom immediately.
